(19) United States
(12) Patent Application Publication
(10) Pub. No.: US 2016/0074921 A1
(43) Pub. Date: Mar. 17, 2016

(54) MACHINE TO PRODUCE PERFORATED METAL STOCK

(71) Applicant: Helix International, Inc., Elk Grove Village, IL (US)

(72) Inventor: Wilhelmus P.H. Castricum, Ormond Beach, FL (US)

(73) Assignee: Helix International, Inc., Elk Grove Village, IL (US)

(21) Appl. No.: 14/835,143

(22) Filed: Aug. 25, 2015

Related U.S. Application Data
(60) Provisional application No. 62/051,702, filed on Sep. 17, 2014.

(51) Int. Cl. B21D 28/26; B01D 29/31; B01D 46/24; B21D 31/02

(52) U.S. Cl. CPC B21D 28/26; B21D 31/02; B01D 29/31; B01D 46/2403

(57) ABSTRACT

A machine to form a plurality of perforations in an elongate strip of material is provided. The machine includes opposed first and second wheels that receive the strip therethrough. The first wheel has a plurality of spaced teeth each disposed at a lateral position about the circumference of the first wheel with consistent spacing therebetween. The second wheel has two or more radial projections that each are disposed outboard of the plurality of spaced teeth in the first wheel. The interaction of the plurality of teeth and radial projections upon the elongate strip forms a plurality of perforations in the strip. Opposed third and fourth wheels are provided after the first and second wheels. The fourth wheel includes at least one indented portion that is aligned to interact with flared portions from the elongate strip and urge the flared portions toward the remaining surface of the elongate strip.

### CROSS-REFERENCE TO RELATED APPLICATIONS

This application claims priority from U.S. Provisional Application No. 62/051,702, filed on Sep. 17, 2014, the entirety of which is hereby fully incorporated by reference herein.

### FIELD OF THE INVENTION

The field of the invention is that of manufacturing tubing and forming tubing from coilstock, which is typically steel. The field of the invention also includes processing the coilstock as desired and then forming the tubing spirally, and cutting the cylindrical spiral wound coilstock to desired length. The lengths of cylindrical spiral wound coilstock may be used for filters of all types, air, oil, and water, and separators. Such tubing may also be used for heating, ventilating, and air-conditioning (HVAC) systems as well as silencers.

### BRIEF SUMMARY

One embodiment is an apparatus for continuously perforating coilstock and forming tubing. The apparatus includes a machine for producing perforated elongate strips. The machine includes a rotatable first wheel aligned to rotate about a first rotational axis, the first wheel having an outer circumferential surface, the first wheel comprising a plurality of first teeth that each radially extend from the outer circumferential surface such that each tooth of the plurality of first teeth are disposed upon a first lateral position upon the width of the outer circumferential surface, with each of the plurality of first teeth being positioned with a space disposed between neighboring teeth of the plurality of first teeth, wherein each of the plurality of first teeth have opposite first and second side surfaces that each face a direction parallel to the first rotational axis, wherein each of the plurality of first teeth include a cutting edge. A rotatable second wheel is aligned to rotate about a second rotational axis, the second wheel includes a first radial projection and a second radial projection spaced from the first projection, where each of the first and second projections extend radially outward around an entire outer circumference of the second wheel a constant radial distance, wherein each of the first and second radial projections are disposed at respective first and second lateral widths of the second wheel, wherein the first radial projection is disposed just outboard of the collective first side surfaces of the plurality of first teeth, and the second radial projection is disposed just outboard of the collective second side surfaces of the plurality of first teeth. The machine is configured to supply an elongate strip of material between the first and second rollers such that a tooth from the first plurality of teeth and the first and second radial projections simultaneously interact with the elongate strip when provided therebetween, and such that rotation of the first wheel in the first direction urges the elongate strip to longitudinally translate therethrough. In use, the plurality of first teeth each cut and extend through the elongate strip to create a plurality of longitudinally aligned apertures in a central portion of the elongate strip and bend portions of the elongate strip to form flared portions that extend toward the second wheel, with flat portions of the elongate strip neighboring each of the plurality of apertures.

Another representative embodiment of the disclosure is provided which may be used with the embodiment above. The embodiment includes a first wheel with also first wheel further comprises a plurality of second teeth that each radially extend from the outer circumferential surface of the first wheel such that each tooth of the plurality of second teeth are disposed upon a second lateral position upon the width of the outer circumferential surface, wherein the second lateral position is spaced from the first lateral position to define a first gap at least slightly longer than a width of the second radial projection, wherein each of the plurality of second teeth are constructed in the same manner as the plurality of first teeth, wherein a portion of the second radial projection extends within the first gap.

Another representative embodiment of the disclosure is provided which may be used with the embodiments above. The embodiment includes a finger that extends horizontally through the first gap and below an outer surface of the second radial projection, wherein a second gap is defined between the outer surface of the second radial projection and an upper surface of the finger, wherein the finger extends through the first gap in a direction opposite of which the elongate strip is urged to longitudinally translate past the first and second wheels, and wherein finger is aligned such that when provided the elongate strip slides along the upper surface of the finger.

Another representative embodiment of the disclosure is provided which may be used with one or more of the embodiments above. The embodiment includes third and fourth wheels rotatably disposed such that the elongate strip extends therebetween after translating through the first and second wheels, wherein the third wheel includes a uniform circumference that interacts with the central portion of the elongate strip, and the fourth wheel comprises at least one indented portion, wherein a centerline of the at least one indented portion is aligned with a centerline of the second radial projection of the second wheel.

Yet another embodiment of the disclosure is provided. The embodiment includes a machine for producing a perforated elongate strip. The machine includes a rotatable first wheel aligned to rotate about a first rotational axis, the first wheel having an outer circumferential surface, the wheel comprising a plurality of first teeth that each radially extend from the outer circumferential surface such that each tooth of the plurality of first teeth are disposed upon a first lateral position upon the width of the outer circumferential surface, with each of the plurality of first teeth being positioned with a gap disposed between neighboring teeth of the plurality of first teeth, wherein each of the plurality of first teeth have opposite first and second side surfaces that each face a direction parallel to the first rotational axis. A rotatable second wheel aligned to rotate about a second rotational axis, the second wheel includes a first radial projection and a second radial projection spaced from the first, wherein the first radial projection is disposed just outboard the collective first side surfaces of the plurality of first teeth, and the second radial projection is disposed just outboard of the collective second side surfaces of the plurality of first teeth. A rotatable third wheel and an aligned rotatable fourth wheel are provided, each aligned to receive an elongate strip after the elongate strip passes through the first and second wheels, the fourth wheel comprising at least one indented region on an outer circumferential surface thereof. The machine is configured to supply an elongate strip of material between the first and second rollers such that a tooth from the first plurality of teeth and the first and second radial projections simultaneously interact with the elongate strip when provided therebetween, and such that rotation of the first wheel in the first direction urges the elongate strip to longitudinally translate therethrough. In use, the plurality of first teeth each cut and extend through the elongate strip to create a perforation in a central portion of the elongate strip and bend portions of the elongate strip to form flared portions that extend toward the second wheel, with flat portions of the elongate strip neighboring the apertures. In use, the central portion of the elongate strip extends between the third and fourth wheels such that one or more of the flared portions interact with the indented region and bend the flared portions toward a surface of the elongate strip.

In addition to the above-mentioned embodiments, the disclosed embodiments also have the advantage of expanding coilstock in a manner that leaves the edges of the coil strip material solid, before it is made into a spirally wound tube. Solid edges make the tube-forming processes easier and the tube itself stronger, compared to a tube with edge-to-edge fully expanded strip material. There are many embodiments of the disclosure, only a few of which are depicted in the attached drawings and which are discussed in the description below. It will be understood that the drawings and descriptions are meant to be descriptive, not inclusive, and that the invention will be defined by the claims below, and their equivalents.

### BRIEF DESCRIPTION OF THE DRAWINGS

FIG. 1 is a perspective view of a cylinder that is made from an elongate perforated strip.

FIG. 2 is a machine that is configured to form the elongate perforated strip and the cylinder of FIG. 1.

FIG. 2a is another machine that is configured to form the elongate perforated strip and the cylinder of FIG. 1.

FIG. 3 is a schematic view of the elongate strip after it has passed through the first and second wheels of the machine of FIG. 2 or 2a.

FIG. 3a is a sectional longitudinal view of the elongate strip after it has passed through the first and second wheels.

FIG. 3b is the view of FIG. 3a with the neighboring end portions of the elongate strip being fixed together to form a lockseam between two portions of the elongate strip.

FIG. 4 is a schematic view of the elongate strip after it has passed through the fifth and sixth wheels of the machine of FIG. 2a.

FIG. 4a is a sectional view of a portion of the strip of FIG. 4 about the section Z-Z.

FIG. 5 is a partial sectional view of the first and second wheels with an elongate strip disposed therebetween.

FIG. 5a is a detail view of detail B of FIG. 5.

FIG. 6 is the view of FIG. 5 with the elongate strip removed.

FIG. 7 is a front view of a first wheel usable with the machine of FIG. 2 or 2a.

FIG. 7a is a detail view of detail B1 of FIG. 7.

FIG. 8 is a partial front view of another first wheel usable with the machine of FIG. 2 or 2a, and showing a plurality of fingers disposed within gaps between neighboring sets of teeth upon the first wheel.

FIG. 9 is a partial side view of the first and second wheels showing the elongate strip disposed therebetween.

FIG. 10 is a view of detail J1 of FIG. 7, showing a top view of a tooth from the first wheel.

FIG. 11 is a perspective view of the first wheel of the machine of FIG. 2 or 2a showing a plurality of teeth radially extending from the circumferential surface of the first wheel.

FIG. 12 is a perspective view of the finger shown in FIG. 5 and elsewhere.

FIG. 13 is a partial sectional view of the third and fourth wheels of the machine of FIG. 2a with an elongate strip disposed therebetween.

FIG. 14 is the view of FIG. 13 with the elongate strip removed.

FIG. 15 is a partial sectional view of the fifth and sixth wheels of the machine of FIG. 2a with an elongate strip disposed therebetween.

FIG. 16 is the view of FIG. 15 with the elongate strip removed.

FIG. 17 is a top view of a strip with formed by the wheels of the machines of FIG. 2 or 2a.

### DETAILED DESCRIPTION OF THE DRAWINGS AND THE PRESENTLY PREFERRED EMBODIMENTS

The machinery and process line 2000 used to provide a plurality of holes, apertures, or perforations 22 (collectively referred to herein as perforations for the sake of brevity, with any differences between the formation of holes, apertures, or perforations discussed in detail below) in predetermined positions within an elongate sheet of metal, such as an unwound coilstock (or elongate strip) 10 is provided herein. The perforated metal material may be formed into a hollow cylinder and cut into desired sizes, or alternatively the perforated material may be maintained in a flat form in desired lengths or in another configuration.

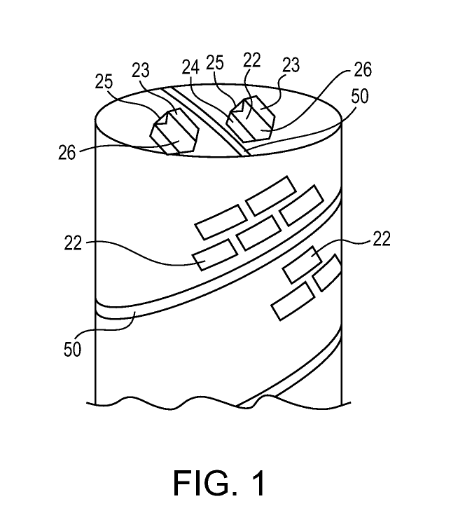

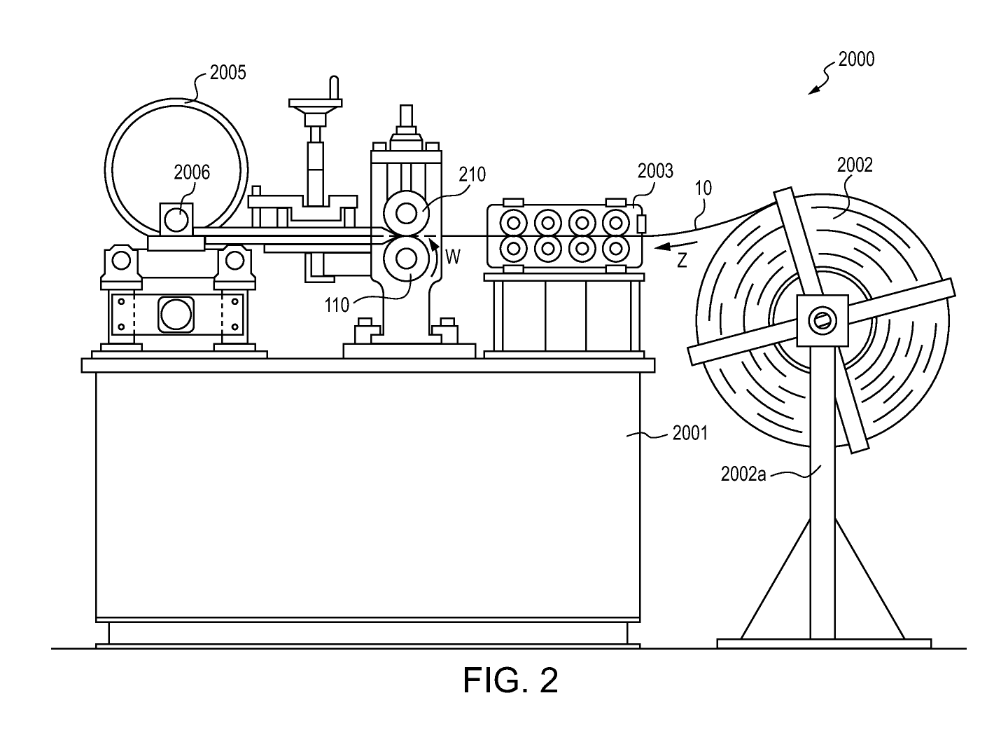

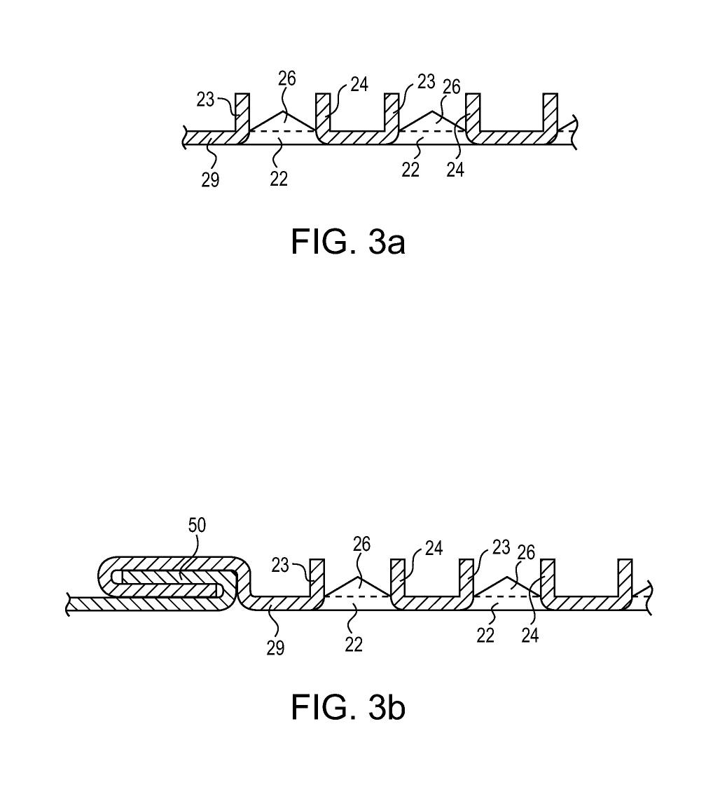

The machinery that accomplishes this process may begin with steel or aluminum coilstock, or other metal or material as desired, and ends with tubing as depicted in FIG. 1, which is then preferably cut into desired lengths automatically. As shown in FIG. 2 a first embodiment, of a processing line 2000 that is suitable to form a cylindrical tube with a plurality of holes or perforations is depicted in FIG. 2. The equipment is preferably mounted rigidly on a base 2001. The machine may receive with coilstock 10 that is fed from an unwinder 2002, into a form roll unit (FRU) 2003. The unwinder 2002 may be supported upon its own stand 2002a (to allow the unwinder to be positioned remotely from the base 2001, or in other embodiments, the unwinder 2002 may be directly supported by the base (by a stand or another structure). The form roll unit 2003 takes flat coilstock and uses rotary forming dies to bend the opposite edge portions 13, 14 of the coilstock 10 into desired profiles to allow the coilstock 10 to be fed through the remainder of the machine 2000. In some embodiments, the form roll unit bends the opposite edge portions 13, 14 into corresponding shapes that mate together and may be pressed into a lockseam 50 when the coilstock 10 is sent through a pipe forming machine 2005, such as a forming head. In some embodiments, the form roll unit may bend the opposite edge portions 13, 14 into a channel 13a and a flange 14a, as depicted on FIG. 5. As can be understood, when forming a lockseam, the flange 14a of one section of coilstock extends into the channel 13a of the neighboring section, and the flange 14a and channel 13a are compressed, or crimped to define a stable and tight lockseam 50 between the two neighboring portions to ensure the integrity of the cylinder.

In some embodiments, the machine 2000 may additionally include a cutting machine 2006 that cuts the formed cylindrical pipe into desired lengths during continuous operation of the machine 2000.

In some embodiments shown in FIG. 2, the machine 2000 may include opposed first and second wheels 110, 210 that simultaneously engage the coilstock 10 and form a plurality of perforations 22 within a central portion 12 of the coilstock 10. In some embodiments as shown in FIG. 2a, the machine 2000 may additionally include a second set of wheels 310, 410 positioned after the first set of wheels (110, 210) (such that the coilstock 10 interacts with the second set of wheels 310, 410 after interacting with the first set of wheels 110, 210), and in some other embodiments, a third set of wheels 510, 610 may be disposed downstream of the second set of wheels 310, 410.

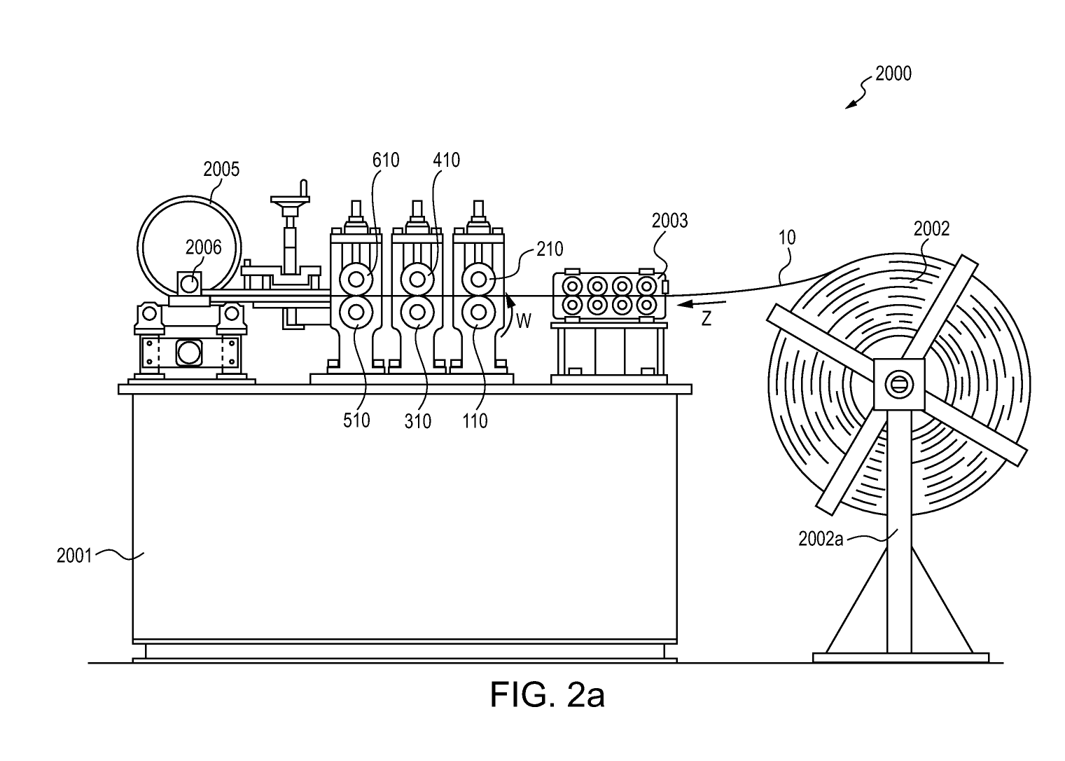

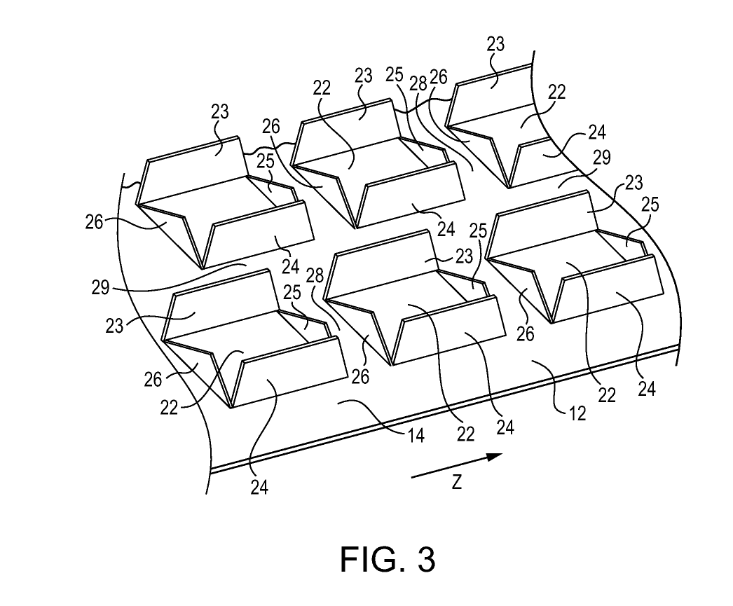

As discussed in greater detail below, the second set of wheels 310, 410, and the third set of wheels 510, 610 when provided assist with bending the flairs 23, 24, 25, 26 (FIG. 1, 3, 5, 9) that are created after the first set of wheels 110, 210 creates perforations 22 in the coilstock 10 moving therepast, as shown in FIG. 3. The second and third sets of wheels bend the flairs 23, 24, 25, 26 to an orientation where they are parallel or nearly parallel (such as within 1 to 5 degrees away from parallel) to the surface of the coilstock bordering each flair as shown in FIG. 4. The second and third sets of wheels 310, 410 and 510, 610 may also bend the flairs into a parallel or nearly parallel orientation with a smooth bend to minimize sharp edges in the coilstock defining each perforation 22.

The first and second wheels 110, 210 are shown in a meshed relationship in FIGS. 5, 6, and 9. The first and second wheels 110, 210 may be aligned with rotational axes 1001, 1002 (respectively) that are parallel as schematically depicted in FIG. 5. In some embodiments, the first wheel 110 may be driven by a transmission with the second wheel remaining idle, while in other embodiments both the first and second wheels 110, 210 may be driven. The machine 2000 may include a single motor that drives a transmission that provides torque to each of the driven wheels in the machine (e.g. all six of the wheels, or in some embodiments only the first wheel 110 and/or the third and fifth wheels 310, 510 when provided, or another combination of driven wheels as needed to provide sufficient torque to each of the sets of wheels to effectively interact with the coilstock 10 passing therebetween, and with sufficient torque to urge linear movement of the coilstock through the appropriate sets of wheels. In other embodiments, various wheels may be driven by separate transmissions and prime movers (such as the first and second wheels 110, 210 driven by different transmissions and/or different prime movers) in embodiments where the timing between opposed wheels is not critical, or timing between neighboring sets of wheels is not critical.

The first wheel 110 is shown in FIGS. 5-10 and is rotatably mounted within the machine 2000 to continuously receive a coilstock 10 such that the coilstock 10 interacts with the outer circumference of the first wheel 110 and specifically the one or a plurality of sets of teeth (discussed in detail below) that extend from the outer circumference. In embodiments where the first wheel 110 is driven, the torque of the first wheel 110 and the engagement between the plurality of sets of teeth and the coilstock urges the coilstock linearly past the wheel 110.

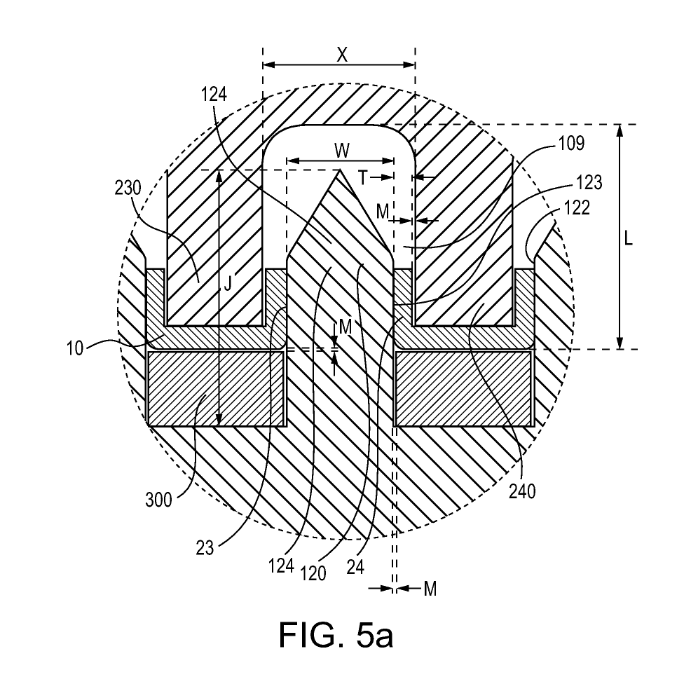

The first wheel may include one set of teeth 120 or several neighboring sets of teeth (120, 140, 160, 180, 190, 194, including more or less sets than those shown in the figures) that each extend radially outward from the circumference of the first wheel 110. In some embodiments, each tooth upon the first wheel 110 is the same size and shape such that all of the teeth, regardless of position on the first wheel 110, forms the same size and shape perforation 22 upon the elongate strip 10 (coilstock). The plurality of teeth may be disposed with a single set of teeth 120 that are each spaced around the circumference of the wheel 110 (along the same line, see element 120a in FIG. 8), in some embodiments evenly spaced between each neighboring tooth around the circumference, or in other embodiments differently spaced between differing neighboring teeth. In some embodiments the teeth may be arranged into multiple parallel sets of teeth 120, 140, 160, 180, 190, 194 (including less or more parallel sets of teeth than depicted in the figures). Each set of teeth is arranged upon the width of the wheel at a constant lateral position. In some embodiments, each set of teeth is arranged with the same space X (FIGS. 5, 6, 7a) between neighboring sets of teeth, while in other embodiments different neighboring sets of teeth may be arranged with differing spaces between neighboring sets of teeth.

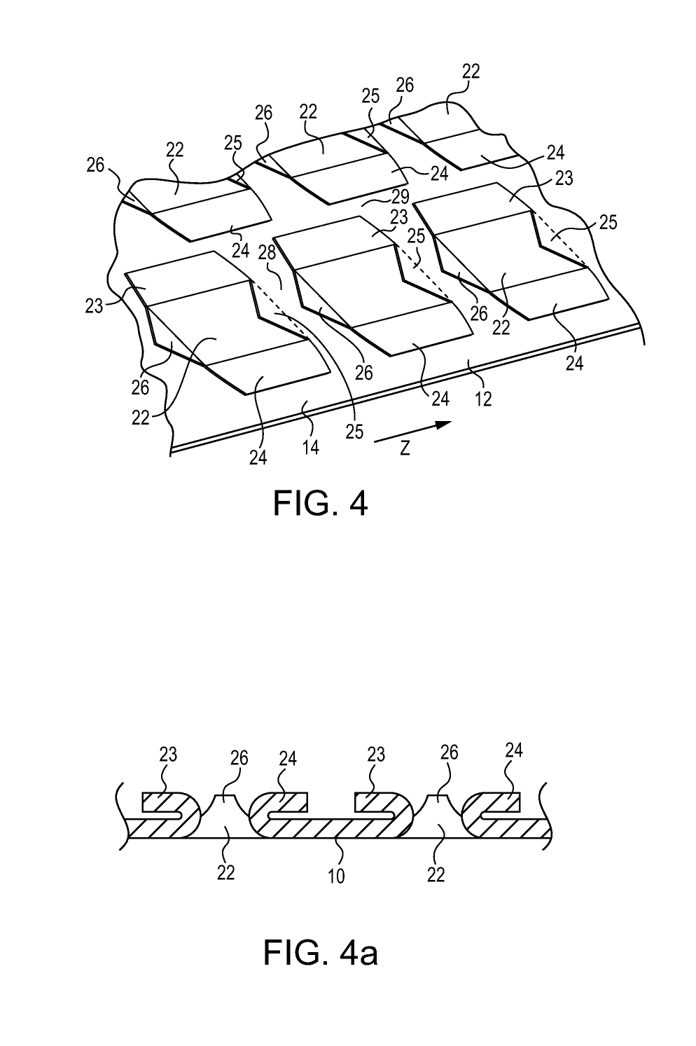

As shown in FIGS. 5, 5a, and 6, the space X between neighboring teeth, and specifically the space X between the side surfaces 123 and 122 of teeth of neighboring sets of teeth (e.g. 120 and 140) defines a void 109 that receives a radial projection (e.g. the first radial projection 230) from the second wheel 210 therein. In some embodiments, the space X may be a multiple of coilstock thickness (T, FIG. 5), such as 6 or 8 times the coilstock thickness T. In other embodiments, the space X may be a multiple of the material thickness (such as 6 or 8) plus twice the space M (defined below). The first and second wheels 110, 210 may be aligned with respect to each other such that a gap K (FIG. 6) between a side surface 122 of a tooth (e.g. 140) and a side surface 223 of the radial projection (e.g. 230) that extends into the void 109 forms a gap K, which may be just thicker than the thickness T (FIG. 5) of the coilstock 10 that is used with respect to the machine 2000. As shown in FIG. 5a, there is a space M between the coilstock 10 (and specifically the portion of the coilstock that forms a flare 23, 24) and the side surface of one of the neighboring teeth (e.g. 120) and the radial projection (e.g. 230). In some embodiments the first and second wheels 110, 210 may be aligned such that M equals 0.002 inches, or other similar small lengths.

In some embodiments, the gap K is provided on each opposite side of the respective radial projection (e.g. radial projection 230, surrounded by first and second sets of teeth 120, 140), such that the space X is just wider than the width W of each radial projection and twice of the thickness (e.g. X>Y+2 times T; or X=2 times (T+M)) and such that K is just wider than the thickness T of the coilstock by the length of the space M.

In some embodiments, the first and second wheels 110, 210 may be arranged such that a center of each radial projection is positioned in the center of each void 109 between neighboring sets of teeth.

In some embodiments, the void 109 between neighboring sets of teeth (e.g. 120, 140) extends radially below a radial height that the coilstock approaches the first wheel 110, and in some embodiments a radius below (smaller than) a radius of one or both the first and second end portions 150, 151 of the first wheel (discussed below) which guide the coilstock 10 through and past the first wheel 110. In these embodiments, the void may receive a portion of a finger 300 extending therethrough. The finger 300 may be fixed upon the machine 2000 with respect to the rotating first wheel 110 and is configured to support and guide the coilstock 10, and specifically the portions of the coilstock that bridge adjacent perforations 22 as it passes through the first wheel 110.

As mentioned above, each tooth radially extends from the first wheel 110 and may be formed with the same size and/or geometry such that each tooth (in combination with the second wheel 210) forms the same size and shaped perforation upon the coilstock. Alternatively, as discussed below, teeth from differing sets of teeth (e.g. 120, 140, 160, 180, 190, 194 etc.) may be formed with teeth of differing size and/or geometry (but with a consistent size and/or geometry within each set). Still further, teeth within a set of teeth (e.g. 120) may selectively be formed from differing size/geometry within each set.

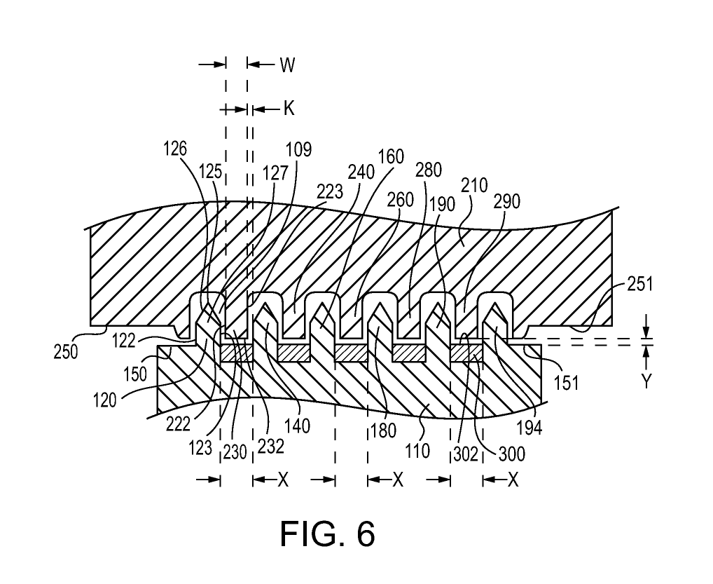

The geometry of the teeth are best shown in FIGS. 5, 5a, 6, 7, 7a, 8, 9, and 10. Each tooth includes opposite right and left side surfaces 122, 123 that are each parallel to the direction of travel of the coilstock (and each face in a direction parallel to the rotational axis 1001 of the first wheel 110), and opposite front and rear surfaces 128a, 129a that each extend in a direction parallel to the rotational axis 1001 of the first wheel. The opposite side surfaces may be planar, or may be arcuate (such as the front and rear surfaces 128a, 129a, FIG. 9). In some embodiments, each tooth may have a tip portion 124 formed at the end of the tooth. The tip portion 124 may include a longitudinal cutting edge 125 that extends along the length of the tooth, such as with opposite ends 125a and 125b that are proximate to the front and rear surfaces 128a, 129a, respectively. The cutting edge 125 may be sharpened.

In some embodiments, each tooth may be formed with the same size and geometry, while in other embodiments, teeth in different rows (e.g. 120, 140, etc.) may be different. A representative tooth is discussed here, and one of ordinary skill in the art will understand that the size and geometry of the teeth may be different based upon the sizes and geometries of the other components of the machine 2000 as well as based different sized coilstocks 10 to be used with the machine 2000. In a representative embodiments the teeth may be 0.19 inches tall (J, FIG. 5a), with a portion that extends above the finger 300 (discussed in detail elsewhere herein) for 0.13 inches (L, FIG. 5a). The finger may be 0.072 inches wide (in the direction parallel to the rotational axis 1001), and 0.2 inches long (in the direction perpendicular to the rotational axis 1001) measured at the base of the tooth. The side surfaces of the teeth within at least the top portion 124 may be formed with an involute curve with a radius of 0.65 inches. The top portion 124 of the tooth may include chamfered side surfaces 126, 127 that meet at the cutting edge 125 that each are set an angle of 30 degrees from the vertical (e.g. from a plane through the respective side surface 123, 124). Each set of teeth (e.g. 120, 140) may include 45 teeth, with the centerlines of each tooth equally spaced 8 degrees apart. Neighboring teeth within a set may be spaced at 0.099 inches apart (back of one tooth to front of neighboring tooth).

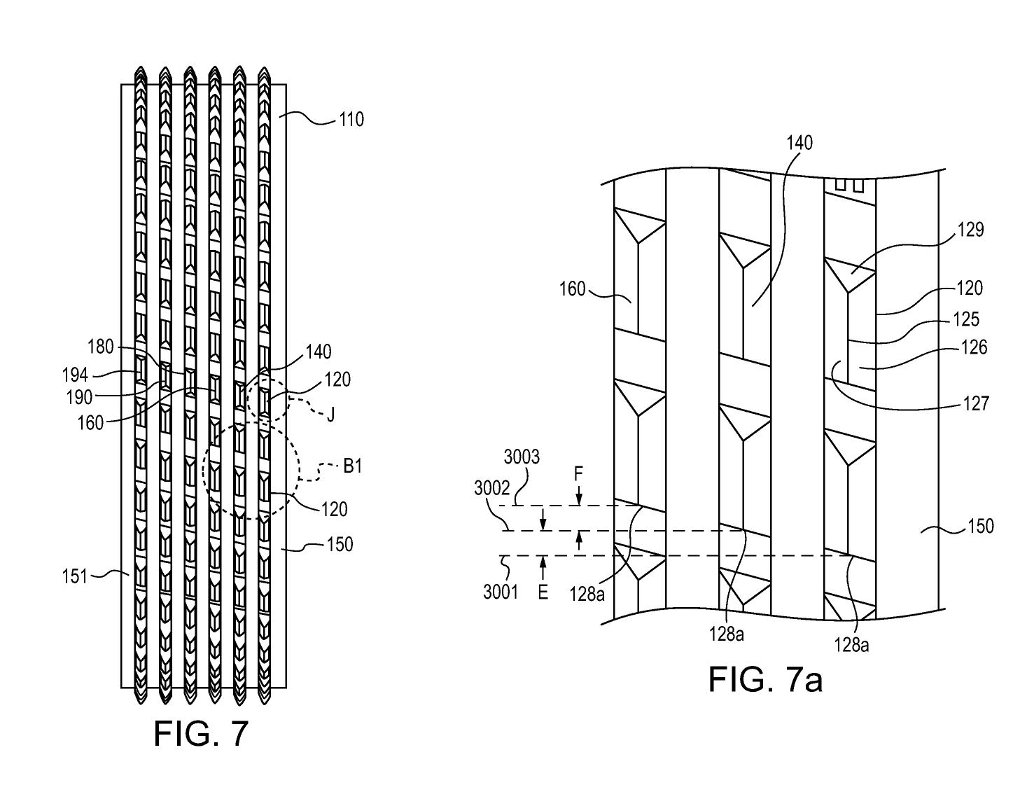

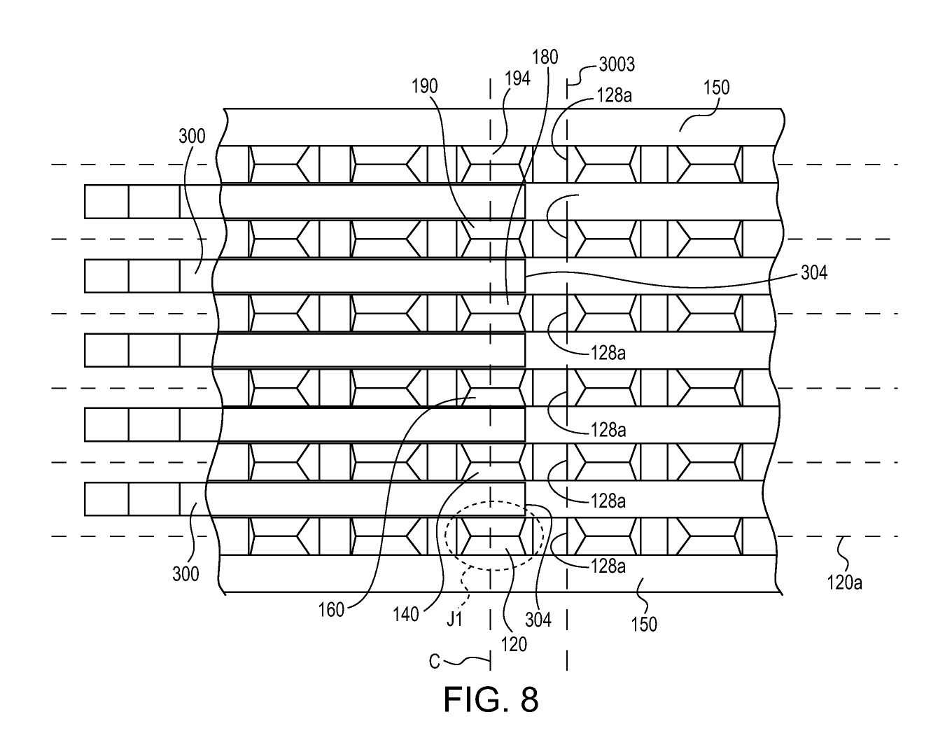

The tip portion 124 may be further defined from angled (which may be planar or arcuate) portions of the right and left side surfaces 126, 127 (of right and left surfaces 122, 123, respectively) and with angled or arcuate portions of the front and rear surfaces 128, 129 (of front and rear surfaces 128a, 129a, respectively). These angled surfaces provide a transition from the lower portion of the respective surface of the tooth. In some embodiments, upon the tip portion 124, the edges, which may act as auxiliary cutting edges (131, 132, 133, 134; FIG. 10) may be formed between neighboring surfaces, and in some embodiments these edges may be sharpened to also form cutting edges. As one of ordinary skill in the art will understand with a thorough review of the subject specification and figures, the cutting edges (which may be sharpened) are configured to cut through the thickness of the coilstock 10 passing between the first and second wheels 110, 210, with the assistance of the radial projections (e.g. 230, 240, etc.) that are aligned between neighboring teeth. As shown in FIG. 11, in some embodiments, the front and rear surfaces 128a, 129a may be formed with a continuous curve to the respective cutting edge, while in other embodiments, the front and rear surfaces 128a, 129a may be discontinuous, with the angled portion 128, 129 being discontinuous with the remainder of that respective surface. Similarly, in some embodiments the right and left surfaces may have a continuous curve (which would be similar to the continuous front and rear surfaces 128a, 128b depicted in FIG. 11), or in the right and left surfaces 122, 123 may be discontinuous within and below the tip portion (as specifically depicted in FIG. 11).

As depicted in FIGS. 3, 5, and 9, each depicting the interaction with the tooth and the coilstock, as the first wheel 110 rotates in the direction G and the coilstock translates over the surface of the wheel 110 in the direction Z, causes a tooth (e.g. a tooth of the first set 120) to initially contact the bottom surface of the coilstock 10. As the wheel 110 further rotates, the coilstock 10 is prevented from upward movement (away from the approaching tooth) due to simultaneous interaction with the approaching respective radial projection (e.g. 230). Continued rotation of the wheel 110 causes the cutting edge 125 to cut through the coilstock, and with continued rotation the size of the cut through the coilstock increases as the various angled surfaces extend through the coilstock, until the perforation because substantially rectangular.

The cutting of the coilstock and the creation of the perforation 22 (as the perforation is expanded from the initial cut made by the cutting edge 125 to a larger perforation as the tip portion 124 further engages the coilstock) causes flairs to be bent upward (away from the first wheel 110). Specifically, right and left flairs 23, 24 (FIGS. 3 and 5) are bent upward and extend parallel to the direction of travel Z of the coilstock 10, and front and rear 25, 26 flairs are bent upward and extend perpendicular to the right and left flairs 23, 24.

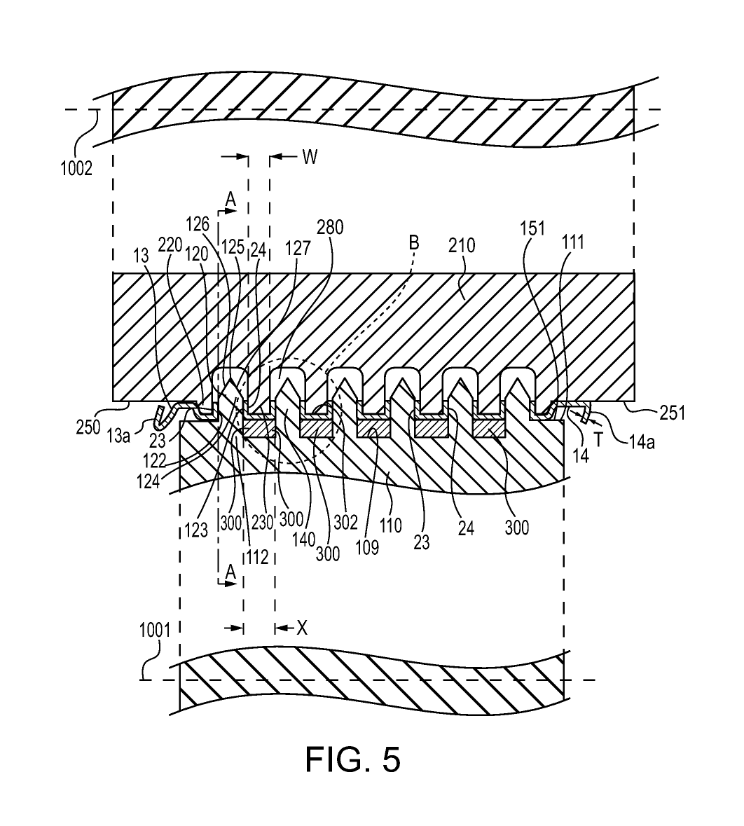

In embodiments where the first wheel includes two or more sets of teeth (e.g. 120, 140, 160, etc.) the teeth in each set may aligned in different relative alignments with respect to each other. In a first embodiment shown in FIGS. 7 and 7a, neighboring teeth of neighboring sets of teeth may be circumferentially staggered along the wheel, such that a leading surface 128a of a tooth from a first set of teeth (e.g. 120) (aligned at line 3001 of FIG. 7a) may be positioned ahead of a leading surface 128a (aligned at a line 3002) of the neighboring tooth from the neighboring second set of teeth (e.g. 140) at a distance E, and a leading edge (3003) of a tooth from a third set of teeth (e.g. 160) may be positioned behind the tooth from the second set at a distance F, and so on. In some embodiments, the distances E and F (and other similar distances) may all be consistent to allow for consistently spaced perforations 22 upon the coilstock, while in embodiments where the perforations are desired to be staggered at different distances, these distances may be different (and in other embodiments, a differing number of teeth may be provided in differing sets, different sized teeth, different width spacing between sets of teeth, etc. may be provided to vary the spacing and size of the various perforations that are formed by the machine). One of ordinary skill in the art with a thorough review of the specification and figures will understand how to construct the first and second wheels 110, 210 to obtain the desired pattern of perforations 22 upon the coilstock 10.

In one representative embodiment, the distance E between lines 3001 and 3002 is the distance corresponding to 15 degrees of curvature of the surface of the first wheel, while this staggering may be within a range of 5 to 20 degrees, inclusive of all points therein, such as 5, 10, 15, 20 degrees. One of ordinary skill with a thorough review of this specification will understand that the staggering of teeth may result in a smooth cutting process because all teeth do not simultaneously engage and disengage the coilstock 10 at the same time, and the staggered engagement also may smooth out the longitudinal driving force that the first wheel imparts upon the coilstock in the direction Z.

In other embodiments shown in FIG. 8, the first wheel 110 may be formed with two or more sets of teeth (e.g. 120, 140, 160, etc.) with the laterally adjacent teeth from two or more adjacent sets of teeth aligned at the same circumferential position about the first wheel 110. In other words, as shown schematically in FIG. 8, neighboring teeth may be aligned with respect to each other such that a leading surface 128a of each adjacent tooth is aligned along the same line (3003, FIG. 8). In some embodiments the teeth along the entire width of the first wheel may all be aligned along the same line (3003, as in FIG. 8), while in other embodiments, various pairs of teeth may be aligned together, with other pairs of teeth being aligned along different circumferential lines.

In some embodiments, the first wheel 110 may have opposed first and second end portions 150, 151 that are disposed at the ends of the wheel and disposed outboard of the respective outermost sets of teeth. The first and second end portions 150, 151 may be configured to support the end portions 13, 14 of the coilstock 10, and in embodiments where the end portions 13, 14 have been previously formed into opposing components needed to form a lockseam (discussed above), the first and second end portions 150, 151 may be provided with structures to support and align the coilstock and specifically the bent portions used to form the lockseam. In other embodiments, the first and second end portions 150, 151 may be of a constant width (i.e. no specific support formations) and the opposing end portions 250, 251 of the second wheel 210 opposite the end portions 150, 151 may include formations to support the end portions 13, 14, and specifically the opposed portions of the lock seam (as best shown in FIG. 5).

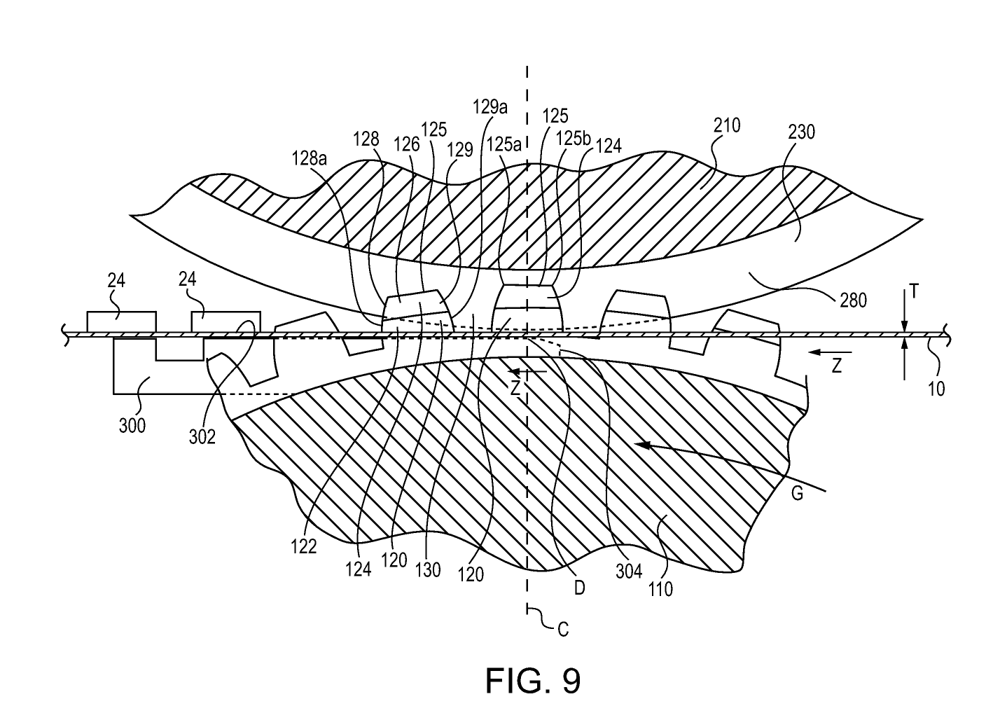

As shown in FIGS. 5, 6, 9, and 12, a one or a plurality of fingers 300 may be fixedly supported with respect to the first and second wheels 110, 210. As discussed above, each void 109 between neighboring sets of teeth (e.g. 120, 140) may receive a finger 300, with the finger 300 positioned such that its upper surface 302 supports a portion of the coilstock 10 located between adjacent perforations 22 along the width of the coilstock (see FIG. 3, element 29). In some embodiments, the finger 300 is fixedly supported by the machine 2000 such that the upper surface 302 of the finger 300 and an outer radial surface 232 of a respective radial projection (e.g. 230) of the second wheel establish a gap Y, depicted in FIG. 6. The gap Y may be just slightly wider than the thickness T (FIG. 5) of the coilstock 10. In a representative embodiment, the gap Y may be equal to the thickness T of the coilstock plus 0.002 inches (or a similar small gap). In some embodiments, the finger 300 may be arranged such that a tip 304 extends through and forward (of a tangent point D (FIG. 9) between the first wheel 110 and the coilstock 10 i.e. in the direction of the coilstock 10 approaching the first wheel 110 such that the coilstock 10 passes the tip 304 before passing by the tangent point D), or in other words, forward of a plane C (FIGS. 8 and 9) that extends through the rotational axis 1001 and through the tangent point D. In some embodiments, the tip 304 of the finger 300 may extend a distance past the tangent point sufficient to support the coilstock before it is initially engaged by an approaching tooth with first wheel 110 rotation, while in other embodiments, the tip 304 of the finger 300 may extend to a position where it interacts with the coilstock 10 after it is initially engaged by an approaching tooth, but before the coilstock reaches the center plane C. In some embodiments, a lower surface 306 of the tip 304 (and rear of the tip 304) may be formed with an arcuate profile with a radius just larger than the radius of the first wheel 110 (and specifically the radius of the bottom 109a of the gap 109 (FIG. 5)) to allow the finger 300 to closely rest above the first wheel 110, but not contact the first wheel 110. In some embodiments, the tip 304 may be chamfered 307 to assist with the transition of the moving coilstock onto the top surface 302 of the finger 300. In some embodiments, the chamfer 307 may be 30 degrees from the top surface 302, but other angles (such as 15, 45, and the like) are also contemplated.

The second wheel is best shown in FIGS. 5 and 6. As discussed above, the second wheel 210 may include one or more radial flanges (230, 240, 260, 280, 290, including more or less than the number of flanges depicted in FIGS. 5 and 6) that each extend radially outward with a constant width along the outer circumference of the second wheel 210. Each radial flange (e.g. 230) is positioned within a void 109 provided between neighboring sets of teeth (e.g. flange 230 is positioned between sets of teeth 120 and 140). An end surface (e.g. 232) of each radial flange extends to a distance Y from the opposing finger 300 (when provided, or if not provided to the outer circumferential surface of the first wheel 110) that is just wider than the thickness of the coilstock. As can be understood with reference to FIG. 5 the proximity between the radial flange 230 and the finger 300 (or outer surface of the first wheel 110) supports the coilstock 10, and specifically the space 90 between neighboring perforations 22 along the width of the coilstock 10) as it passes through first and second wheels 110, 210.

As discussed above, the side surfaces 222, 223 of the radial projection 230 are spaced from the opposing side surfaces of the teeth (e.g. surface 123 of tooth 120 and side surface 122 of tooth 140) at a distance K (FIG. 6) that is just wider than the thickness of the coilstock 10 by a space M. In a representative embodiment the space M is 0.002 inches.

As best understood with reference to FIGS. 5 and 9, as a tooth approaches the coilstock 10, based upon the first wheel's rotation in the direction G (as the coilstock 10 moves in the direction Z, FIG. 9) the cutting edge 125 of the tooth interacts with the bottom surface of the coilstock 10 and eventually pierces through the coilstock 10. With further rotation, the perforation is developed due to the widening of the tip portion 124 as it extends through the coilstock. As the initial cut is made by the cutting edge 125 a linear cut is formed within the coilstock, and then with further rotation two opposite flairs 23, 24 are formed and bent away from the coilstock 10. Flairs 23, 24 are generally parallel to the longitudinal axis of the coilstock (or the direction of motion Z of the coilstock 10 through the machine 2000). The flairs 23, 24 are urged into a perpendicular orientation with respect to the planar surface of the coilstock as the flairs are disposed between the teeth (e.g. 120 and the neighboring radial projections (e.g. 230) of the second wheel 210.

Similarly, the widening of the perforation due to the interaction of the leading and trailing portions 128, 129 of the tip cause flairs 25, 26 to also extend perpendicular to the planar surface of the coilstock 10. The flairs 25, 26 are generally perpendicular to the longitudinal axis of the coilstock (i.e. the direction of motion Z of the coilstock 10 through the machine 2000).

In some embodiments, the perforated coilstock 10 leaving the first and second wheels 110, 210 may be coiled into a cylinder or tube, with the lockseam 50 formed as discussed above. The cylinder may be formed with the flairs disposed within the inner surface of the cylinder (generally extending toward the center of the cylinder, or in other embodiments, the cylinder may be formed with the flairs extending radially outward from the outer surface of the cylinder.

In other embodiments, the perforated coilstock 10 may then pass through one or two additional sets of wheels 310, 410, and potentially 510, 610 to flatten the flairs (as shown in FIGS. 4 and 4a), to form a cylinder as shown in FIG. 1.

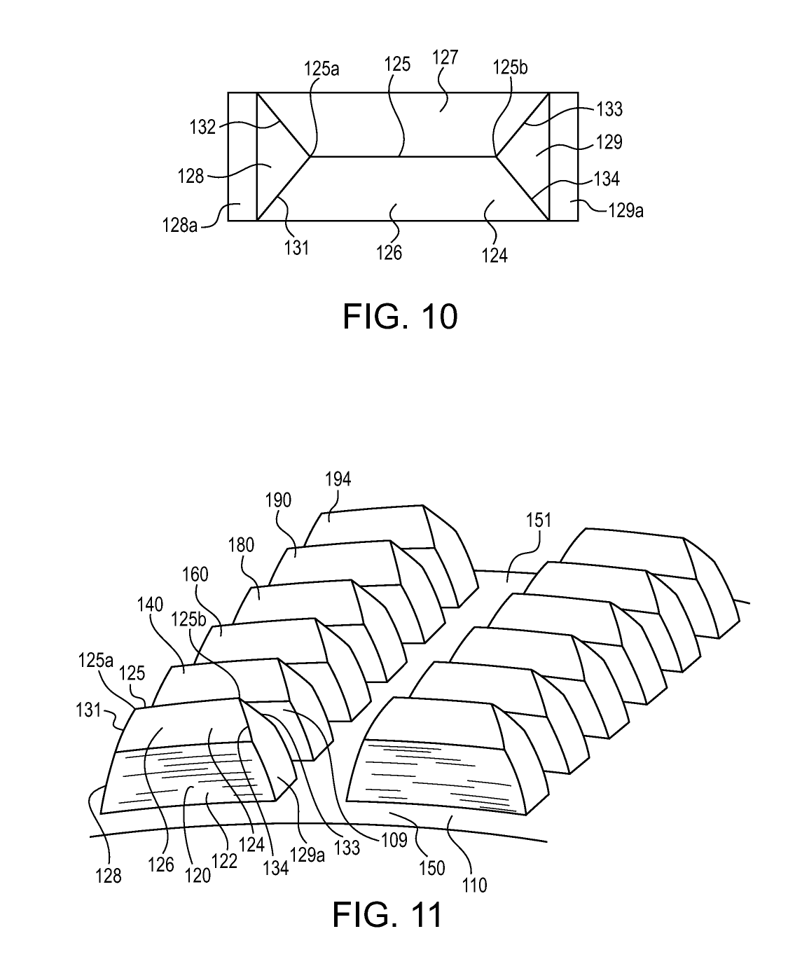

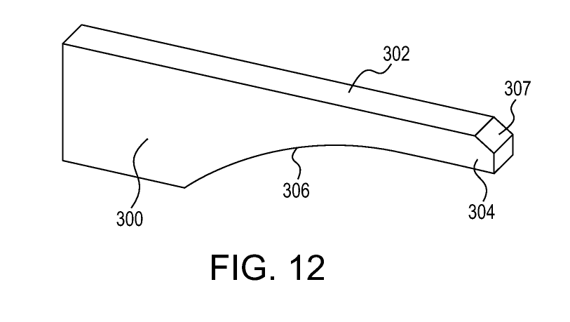

The third and fourth wheels 310, 410 are depicted in FIGS. 13 and 14 and are arranged to receive the coilstock 10 after it has been perforated and passed through the first and second wheels 110, 210. In some embodiments, the third wheel 310 is driven and the fourth wheel is idle, and in other embodiments, the fourth wheel may be driven with the third wheel 310 idle, while in still other embodiments, both wheels 310, 410 may be driven. The speed of the wheels is a function of the radius of the wheels 310, 410, and in some embodiments, velocity of the surface of the wheels may be the same as the velocity of the coilstock 10 passing through the wheels. The angular velocity of the second set of wheels 310, 410 (at least the driven wheels of the second and third wheels) may be the same as the angular velocity of the first wheel 110 (and the second wheel 210 if also driven, and at the same speed) to simplify the transmission, although this is not necessary because in some embodiments there are no timing or synchronization requirements between the first wheel 110 and the coilstock 10 and the third and fourth wheels 310, 410.

In some embodiments, the rotational axes of the third and fourth wheels 310, 410 (not shown, but similar to axes 1001, 1002 of the first and second wheels) may be parallel, while in other embodiments, the rotational axes may be skewed with respect to each other (but still within a single plane).

The third wheel 310 may be a wheel with a uniform diameter along its width, or at least for the portion of the width that supports the central portion of the coilstock 10, with the outer circumferential surface 322 of the wheel configured to support the bottom surface of the coilstock 10 as it passes through (i.e. the surface away from which the flairs extend). In some embodiments, the outer ends of the third wheel 310 may include end portions 350, 351 may be configured to support the end portions 13, 14 of the coilstock 10, and in embodiments where the end portions 13, 14 have been previously formed into opposing components needed to form a lockseam (discussed above), the first and second end portions 350, 351 may be provided with structures to support and align the coilstock and specifically the bent portions used to form the lockseam 50. In some embodiments, shown in FIGS. 13 and 14, the end portions 13, 14 of the coilstock may extend past the ends of the third wheel 310.

The fourth wheel 410 is configured to receive and engage the upper side of the coilstock 10 and specifically to bend the flairs 23, 24, 25, 26 that surround each perforation of the coilstock 10 as the coilstock moves therepast. The fourth wheel 410 may include one or more radial projections (420, 440, 460, 480, 490, as well as more or less than the number shown in FIGS. 13, 14 depending upon the number of perforations formed in the coilstock 10) and one or several indented portions (418, 430, 450, 470, 475, as well as more or less than the number shown in FIGS. 13, 14 depending upon the number of perforations formed in the coilstock 10). In some embodiments, the radial projections and indented portions have the same geometry and position around the circumference of the fourth wheel 410. Each of the radial projections extends toward the coilstock passing therethrough (FIG. 13) and includes a lower planar surface e.g. 422 that establishes a gap Q with the outer radial circumferential surface 322 of the third wheel 310. In some embodiments, the gap Q may be just wider than twice the thickness of the coilstock (due to the engagement and bending of the end flairs 25, 26 by the radial projections as discussed below.

The radial projections (e.g. 420) are aligned with the space created by the perforations 22 upon the coilstock. The radial projections (e.g. 420) each interact with the respective front and rear flairs 25, 26 that extend upward from the coilstock 10 at each perforation, and specifically bend the flairs to an orientation where they are parallel with the remainder of the coilstock 10 (e.g. the gaps 28 between the perforations 22 formed along the same width, and the neighboring perforations along the width of the coilstock 10). As the coilstock 10 approaches the rotating third and fourth wheels 310, 410, the forward flair 25 contacts the respective radial projection (e.g. 420), and due to the small gap Q with the third wheel, the forward flair is bent backward to a position where it again extends within the perforation, and is planar to the coilstock 10 or at a small acute angle with respect to the coilstock, such as 1, 2, 3, 4, 5 degrees (due to the overall size of the gap Q).

With further motion toward the wheels, the radial projection interacts with the trailing flair 26, which is bent backward (i.e. away from the perforation) until it is parallel or close to parallel (such as 1, 2, 3, 4, 5 degrees away from parallel) and forms a sandwich with the coilstock (over the portion 28). The angle of the bent trailing flair 26 is minimized when the gap Q is only smaller than twice the thickness of the coilstock 10 (e.g. 2 times T). The radial projections (e.g. 420) may not interact with the side flairs 23, 24, which instead interact with the indented portions.

The indented portions (e.g. 430) are each aligned with the space 29 between adjacent perforations 22, such that line P that extends through the center of each indentation (and specifically through a vertex 436 of each indentation (e.g. (430)) also extends through the center of a lateral space 29 upon the coilstock 10 between neighboring lateral perforations 22.

Each indentation (e.g. 430) may be formed from opposing side surfaces 434, 435 that meet each other at an end thereof. In some embodiments, one or both of the side surfaces 434, 435 partially or totally planar at a central vertex 436. Alternatively, one or both of the side surfaces 434, 435 may have planar portions but meet with an arcuate portion therebetween. The planar side surfaces may each be orientated at an acute angle α (normally opposing side surfaces are at the same angle, although the side surfaces may be at differing angles). In some embodiments, the angle α may be 45 degrees. In some embodiments, the angle α may be within the range of 30 degrees to 60 degrees (inclusive of all angles within this range), such as for example, 30, 40, 50, or 60 degrees, while in other embodiments the angle α may be within the range of 15 degrees to 75 degrees (inclusive of all angles within this range). In other embodiments, one or both of the side surfaces 434, 435 may be arcuate with a constant or differing curvature along their length.

Each of the opposing planar side surfaces 434, 435 are aligned be just offset from flairs 23, 24 that extend upward from the coilstock 10 from adjacent perforations 22, and the angle α of each planar side surface 434, 435 is configured to bend the flair that contacts the side surface to the angle of the side surface, such that when the side surfaces 434, 435 are at 45 degrees, the flairs 23, 24 that engage the side surfaces are bent to the same 45 degree angle. The coilstock 10 therefore leaves the third and fourth wheels 310, 410 with the side flares bent to the angle α (and extending over the portion 29 of the coilstock between neighboring lateral perforations 22), the forward flair flattened, and the rear flair flattened and sandwiched over the space 28 (FIG. 4) between longitudinal perforations. In some embodiments, the coilstock 10 may then be shaped into a cylindrical form (and lockseam created) similar to the embodiment with only first and second wheels 110, 210 discussed above. Alternatively, the coilstock 10 may then move to between fifth and sixth wheels 510, 610.

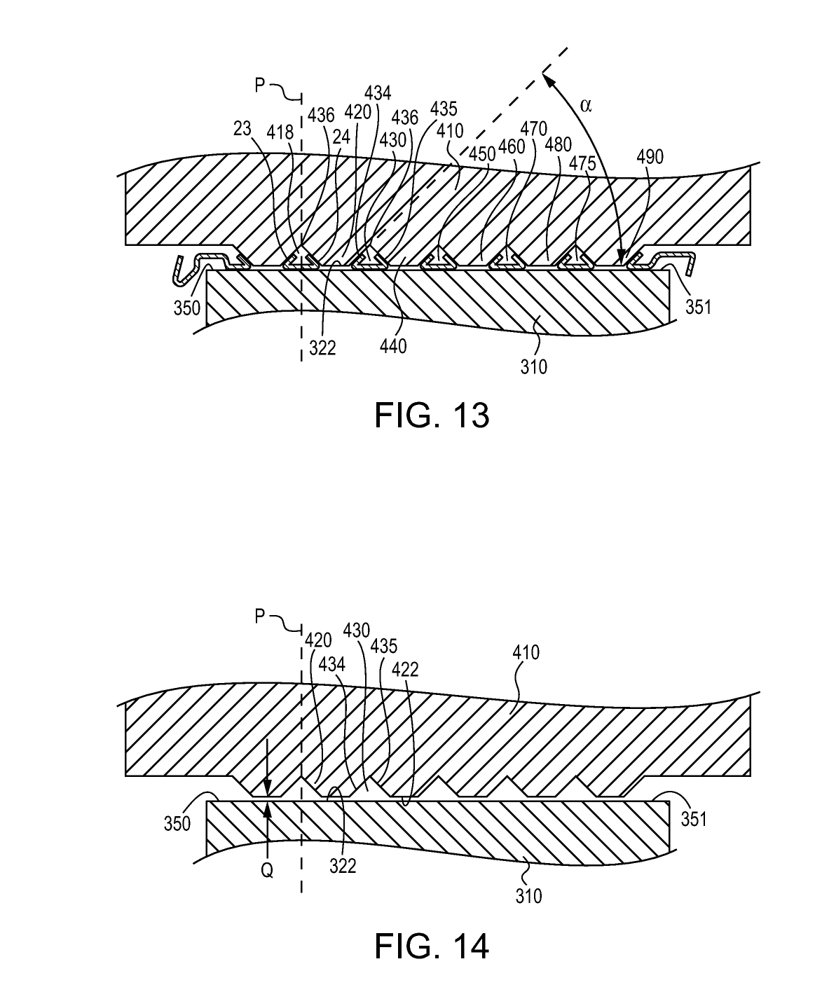

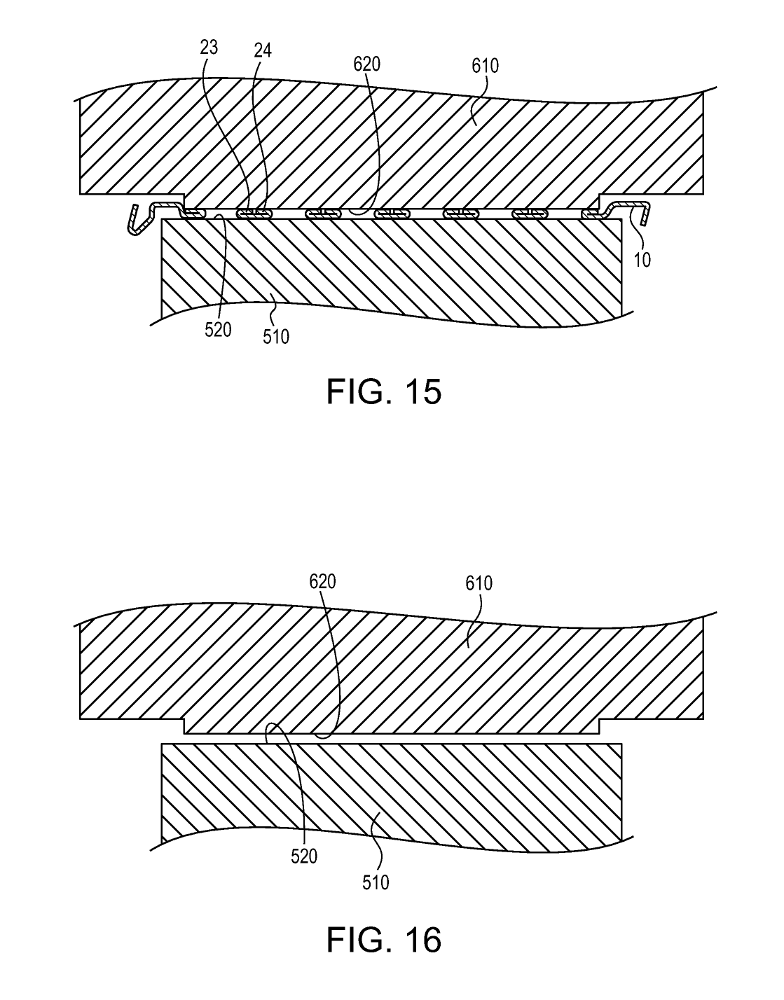

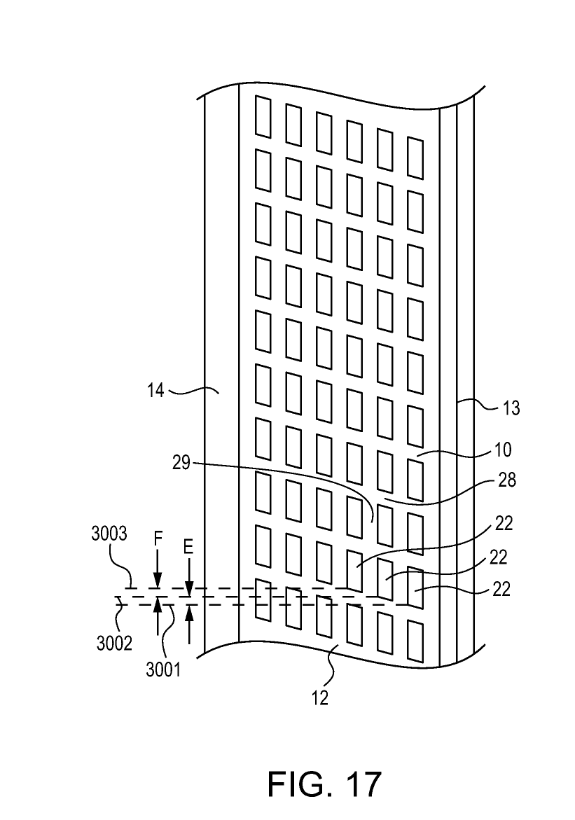

The fifth and sixth wheels 510, 610 are depicted in FIGS. 15 and 16. The fifth wheel 510 may be a wheel with a uniform diameter along its width, or at least for the portion of the width that supports the central portion of the coilstock 10, with the outer circumferential surface 520 of the wheel configured to support the bottom surface of the coilstock 10 as it passes through (i.e. the surface away from which the flairs extend). In some embodiments, the outer ends of the fifth wheel 510 may include end portions 550, 551 may be configured to support the end portions 13, 14 of the coilstock 10, and in embodiments where the end portions 13, 14 have been previously formed into opposing components needed to form a lockseam (discussed above), the first and second end portions 550, 551 may be provided with structures to support and align the coilstock and specifically the bent portions used to form the lockseam 50. In some embodiments, shown in FIGS. 15 and 16, the end portions 13, 14 of the coilstock may extend past the ends of the fifth wheel 510.

The sixth wheel 610 may be formed similarly to the fifth wheel 510, and may be formed with a uniform diameter along its width, or at least for the portion of the width that supports the central portion of the coilstock, with the outer circumferential surface 620 of the wheel configured to engage the flairs and bend them toward the coilstock 10, as discussed below. In some embodiments, the fifth and sixth wheels 510, 610 may be positioned with opposed circumferential surfaces 520, 620 separated by a distance H, which may be just wider than twice the thickness T of the coilstock. In some embodiments, the rotational axes of the fifth and sixth wheels 510, 610 (not shown, but similar to axes 1001, 1002 of the first and second wheels 110, 210) may be parallel, while in other embodiments, the rotational axes may be skewed with respect to each other (but still within a single plane).

In some embodiments, the fifth and sixth wheels 510, 610 are provided after the third and fourth wheels 310, 410, and the continuous surface 622 of the sixth wheel 610 engages the side flairs 23, 24, which were previously bent to the angle α (discussed above) due as the coilstock 10 approaches the leading portion of the sixth wheel, due to the interaction with the fourth wheel 410 and bends the side flairs 23, 24 toward and over the space 29 between laterally adjacent perforations 22. As shown in FIG. 15, the flairs 23, 24 become bent to an orientation that is parallel, or nearly parallel (such as at an angle of 1, 2, 3, 4, or 5 degrees from parallel) to the surface of the coilstock along the space 29. In some embodiments, the bent flairs 23, 24 contact the coilstock 10 along the space 29, while in other embodiments, the bent flairs 23, 24 are just above the surface of the coilstock (due to the distance H being slightly larger than twice the thickness of the coilstock 10.

If the distance H is smaller than the spacing Q between the third and fourth wheels 310, 410, the fifth and sixth wheels 510, 610 may further bend the trailing flair 26 toward the surface of the coilstock 10 at the longitudinal space 28 between aligned perforations 22.

In some embodiments, the fifth and sixth wheels 510, 610 may be provided directly after the first and second wheels 110, 210 that form the perforations and the flairs 23, 24, 25, 26 in the coilstock 10, with the flairs extending generally perpendicular from the surface of the coilstock 10. In those embodiments, as the coilstock approaches the leading surface of the sixth wheel 610, the flat circumferential surface 620 contacts the flairs (initially the leading flair 25, then the side flairs 23, 24, and then the trailing flair 26. The leading flair 25 is pivoted back to a parallel (or nearly parallel, as defined above) orientation within volume of the perforation (as shown in FIG. 4). The side flairs are bent toward the neighboring lateral space 29 upon the coilstock 10 (to double over the flairs 23, 24 over the lateral space portion 29, nearly parallel to the surface of the coilstock 10, and the rear flair 26 is bent to an orientation above a portion of the longitudinal space 28 that trails the perforation 22 and in a sandwiched parallel or nearly parallel (as discussed herein) orientation.

In some embodiments, torque may be provided to the driven wheels (e.g. at least 110, 310, 510) provided via a central prime mover (such as a motor) and one or more transmissions, such as chain or gear drives.

In some embodiments, the perforated coilstock leaving the fifth and sixth wheels 510, 610 (or in other embodiments, the perforated coilstock 10 leaving the first and second wheels 110, 210) passes into a machine 2005 for forming piping or tubing from coilstock. Such machines are disclosed in U.S. Pat. Nos. 4,706,481 and 4,924,684. The descriptions of the pipe forming apparatus contained in these patents, as well as the disclosures in their entirety are hereby incorporated by reference.

In other the perforated (and in some embodiments flattened) coilstock 10 may be maintained in the flattened configuration and not coiled into a cylinder. In still other embodiments, the perforated (and in some embodiments flattened) coilstock may be wound onto a spool (similar to spool 2002 of FIGS. 2 and 2a) for storage or transportation until it is ultimately used.

The coilstock 10 that is used with the machine 2000 may be any width or thickness that is suitable for moving within the components of the machine, and for embodiments where the coilstock is ultimately formed into cylinders, suitable to form a cylinder. In some representative embodiments, the coilstock may be 0.008 inches or 0.016 inches thick (T), or within the range of these thicknesses, inclusive of all thicknesses therein. Alternatively, the coilstock could be other thicknesses. The coilstock 10 may have any standard width, such as 45 mm 75 mm, or 137 mm, or nonstandard widths that might be used for specific applications. The rolls of coilstock 10 may have an outside diameter (when full) of at least 36 inches. The coilstock 10 may be metal, such as stainless steel, aluminum, or copper, or other metals including various appropriate alloys that one of ordinary skill would understand to be appropriate for the desired finished product. The coilstock 10 may be coated or otherwise machined, such as steel tinplate coated, electro galvanized, cold rolled, or the like.

One or more of the wheels (110, 210, 310, 410, 510, 610) may be formed with heat treated tool steel, or other metals with sufficient strength, wear, and hardness properties to be appropriate for the specific wheel. In some embodiments, the wear surfaces may be coated with titanium nitrite or hard chrome.

There are many embodiments of the method used to form coilstock and to make tubing in a continuous process as described above, of which those described above are only a few. Accordingly, it is intended that the foregoing detailed description be regarded as illustrative rather than limiting, and that it be understood that it is the following claims, including all equivalents, that are intended to define the spirit and scope of this invention.

What is claimed is:

1. A machine for producing a perforated elongate strip, comprising:
a rotatable first wheel aligned to rotate about a first rotational axis, the first wheel having an outer circumferential surface, the first wheel comprising a plurality of first teeth that each radially extend from the outer circumferential surface such that each tooth of the plurality of first teeth are disposed upon a first lateral position upon a width of the outer circumferential surface, with each of the plurality of first teeth being positioned with a space disposed between neighboring teeth of the plurality of first teeth, wherein each of the plurality of first teeth have opposite first and second side surfaces that each face a direction parallel to the first rotational axis,
each of the plurality of first teeth includes a cutting edge;
a rotatable second wheel aligned to rotate about a second rotational axis, the second wheel includes a first radial projection and a second radial projection spaced from the first projection, where each of the first and second projections extend radially outward around an entire outer circumference of the second wheel a constant radial distance, wherein each of the first and second radial projections are disposed at respective first and second lateral widths of the second wheel, wherein the first radial projection is disposed just outboard of the collective first side surfaces of the plurality of first teeth, and the second radial projection is disposed just outboard of the collective second side surfaces of the plurality of first teeth; and
the machine is configured to supply an elongate strip of material between the first and second rollers such that a tooth from the first plurality of teeth and the first and second radial projections simultaneously interact with the elongate strip when provided therebetween, and such that rotation of the first wheel in the first direction urges the elongate strip to longitudinally translate therethrough,
wherein in use, the plurality of first teeth each cut and extend through the elongate strip to create a plurality of longitudinally aligned apertures in a central portion of the elongate strip and bend portions of the elongate strip to form flared portions that extend toward the second wheel, with flat portions of the elongate strip neighboring each of the plurality of apertures.

2. The machine of claim 1, wherein the first wheel receives torque to urge rotation in the first direction and the second wheel is idle.

3. The machine of claim 1, wherein the first wheel further comprises a plurality of second teeth that each radially extend from the outer circumferential surface of the first wheel such that each tooth of the plurality of second teeth are disposed upon a second lateral position upon the width of the outer circumferential surface, wherein the second lateral position is spaced from the first lateral position to define a first gap at least slightly longer than a width of the second radial projection, wherein each of the plurality of second teeth are constructed in the same manner as the plurality of first teeth, wherein a portion of the second radial projection extends within the first gap.

4. The machine of claim 3, wherein the machine fixedly supports a finger that extends horizontally through the first gap and below an outer surface of the second radial projection, wherein a second gap is defined between the outer surface of the second radial projection and an upper surface of the finger, wherein the finger extends through the first gap in a direction opposite of which the elongate strip is urged to longitudinally translate past the first and second wheels, and wherein the finger is aligned such that when provided the elongate strip slides along the upper surface of the finger.

5. The machine of claim 4, wherein the finger extends to a tip, wherein the tip extends past a tangent point between the elongate strip and the first wheel, and such that the elongate strip extends over the finger before reaching the tangent point.

6. The machine of claim 3, wherein the second gap is just wider than a thickness of the elongate strip that translates between the first and second wheels.

7. The machine of claim 1, wherein the cutting edge upon each of the plurality of first teeth extends perpendicular to the first rotational axis.

8. The machine of claim 7, wherein each of the plurality of first teeth includes a top portion that includes the cutting edge, wherein the cutting edge is an edge defined between first and second opposed side cutting surfaces, wherein the first side cutting surface extends from the first side surface, and the second side cutting surface extends from the second side surface.

9. The machine of claim 8, wherein each of the plurality of first teeth includes opposed leading and trailing surfaces, which combined with the first and second side surfaces define the outer surfaces of each tooth, wherein the leading and training surfaces are chamfered and meet respective opposite ends of the cutting edge.

10. The machine of claim 9, wherein the top portion includes four auxiliary cutting edges that define the respective transitions between the opposite first and second side surfaces and the opposite leading and trailing surfaces, wherein each of the four auxiliary cutting edges ends at one of the ends of the cutting edge.

11. The machine of claim 3, wherein the first gap is just wider than a sum of the width of the second radial projection and two times the thickness of the elongate strip that translates through the machine.

12. The machine of claim 3, wherein the first and second wheels each include opposite end portions that are configured to support opposite edges of the elongate strip when translating between the first and second wheels, wherein one of the first and second wheels is a constant diameter along the end portions and the other of the first and second wheels includes at least one indexing feature that interacts and supports the respective opposite edge of the elongate strip.

13. The machine of claim 1, further comprising third and fourth wheels rotatably disposed such that the elongate strip extends therebetween after translating through the first and second wheels, wherein the third wheel includes a uniform circumference that interacts with the central portion of the elongate strip, and the fourth wheel comprises at least one indented portion, wherein a centerline of the at least one indented portion is aligned with a centerline of the second radial projection of the second wheel.

14. The machine of claim 13, wherein the at least one indented portion is defined by first and second opposed side surfaces, wherein the first and second planar surfaces are aligned to interact with flared portions of the elongate member.

15. The machine of claim 13, wherein the third roller receives torque to urge rotation in the first direction.

16. The machine of claim 14, further comprising opposed fifth and sixth wheels rotatably disposed such that the elongate strip extends therebetween after translating through the third and fourth wheels, wherein each of the fifth and sixth wheels include a uniform circumference along a portion that interacts with the central portion of the elongate strip.

17. The machine of claim 16, wherein the circumferential surface of the sixth roller is configured to urge the flared portions into an orientation that is sandwiched with a neighboring portion of the elongate strip.

18. The machine of claim 1, wherein the first and second rollers are configured to interact with an elongate strip with opposite edge portions outboard of respective opposite sides of the central portions that are bent with corresponding geometries and configured to establish a lockseam when the elongate strip is urged into a cylindrical shape after the first and second rollers.

19. The machine of claim 3, wherein each of the first plurality of teeth are circumferentially staggered from each of the neighboring second plurality of teeth such that a respective tooth from the first plurality of teeth does not engage the elongate strip at the same time that a neighboring tooth from the second plurality of teeth engages the elongate strip.

20. A cylinder formed by the machine of claim 1, wherein a surface of the elongate strip that faces the first wheel when translating therepast establishes the outer surface of the cylinder and an opposite surface of the elongate strip that faces the second wheel when translating therepast establishes an inner surface of the cylinder, when the machine bends the elongate strip into a cylinder.

21. A machine for producing a perforated elongate strip, comprising:
a rotatable first wheel aligned to rotate about a first rotational axis, the first wheel having an outer circumferential surface, the wheel comprising a plurality of first teeth that each radially extend from the outer circumferential surface such that each tooth of the plurality of first teeth are disposed upon a first lateral position upon a width of the outer circumferential surface, with each of the plurality of first teeth being positioned with a gap disposed between neighboring teeth of the plurality of first teeth, wherein each of the plurality of first teeth have opposite first and second side surfaces that each face a direction parallel to the first rotational axis,
a rotatable second wheel aligned to rotate about a second rotational axis, the second wheel includes a first radial projection and a second radial projection spaced from the first, wherein the first radial projection is disposed just outboard of the collective first side surfaces of the plurality of first teeth, and the second radial projection is disposed just outboard of the collective second side surfaces of the plurality of first teeth;
a rotatable third wheel and an aligned rotatable fourth wheel, each aligned to receive to receive an elongate strip after the elongate strip passes through the first and second wheels, the fourth wheel comprising at least one indented region on an outer circumferential surface thereof,
the machine is configured to supply an elongate strip of material between the first and second rollers such that a tooth from the first plurality of teeth and the first and second radial projections simultaneously interact with the elongate strip when provided therebetween, and such that rotation of the first wheel in the first direction urges the elongate strip to longitudinally translate therethrough,
wherein in use, the plurality of first teeth each cut and extend through the elongate strip to create a perforation in a central portion of the elongate strip and bend portions of the elongate strip to form flared portions that extend toward the second wheel, with flat portions of the elongate strip neighboring the apertures, and
in use the central portion of the elongate strip extends between the third and fourth wheels such that one or more of the flared portions interact with the indented region and bend the flared portions toward a surface of the elongate strip.

22. The machine of claim 21, wherein the at least one indented region includes first and second opposed side surfaces, each of the first and second side surfaces are aligned to interact with flared portions.

23. The machine of claim 22, wherein the first and second opposed side surfaces of each indented region are aligned to interact with flared portions that are formed from different neighboring perforations created in the elongate strip.

24. The machine of claim 22, wherein the first and second opposed side surfaces of each indentation are aligned to bend the flared portions interacting with each respective first and second opposed side surface toward each other.
